(19) United States
(12) Patent Application Publication
(10) Pub. No.: US 2026/0024304 A1
(43) Pub. Date: Jan. 22, 2026

(54) IMAGE DIFFERENCE CAPTIONING FOR A SERIES OF VERSIONS OF A DIGITAL IMAGE WITH APPLIED MANIPULATIONS

(71) Applicant: Adobe Inc., San Jose, CA (US)

(72) Inventors: Jing Shi, Rochester, NY (US); Alexander Black, London (GB); John Collomosse, Woking (GB); Yifei Fan, Santa Clara, CA (US)

(21) Appl. No.: 18/779,587

(22) Filed: Jul. 22, 2024

(51) Int. Cl. G06V 10/75; G06F 40/40; G06V 10/40; G06V 10/774; G06V 10/776; G06V 10/82

(52) U.S. Cl. CPC G06V 10/751; G06F 40/40; G06V 10/40; G06V 10/774; G06V 10/776; G06V 10/82

(57) ABSTRACT

The present disclosure relates to systems, methods, and non-transitory computer-readable media that leverages a series of versions of a digital image to generate a caption prediction. Furthermore, the disclosed systems receive an image difference captioning request that includes a series of versions of a digital image with a series of manipulations applied to the series of versions. Moreover, the disclosed systems access one or more edit descriptions for one or more of the series of manipulations. Further, the disclosed systems generate text inputs from the series of versions of the digital image and the one or more edit description. From the text inputs and using a large language model, the disclosed systems generate a caption prediction that indicates a difference between a first version and a last version of the series of versions of the digital image.

### BACKGROUND

Recent years have seen significant advancement in hardware and software platforms for generating synthetic image content. For example, many software platforms implement technology that can synthetically create visual content to imitate a wide range of subject matter (e.g., deep fakes) that is hard to distinguish from original/authentic content. In response, many existing systems use artificial intelligence to detect deep fake content. However, despite these efforts to detect deep fake content using artificial intelligence, existing systems continue to suffer from a variety of problems with regard to computational accuracy and operational flexibility.

### SUMMARY

One or more embodiments described herein provide benefits and/or solve one or more of the problems in the art with systems, methods, and non-transitory computer-readable media that fuses visual and textual cues for sequential image difference captioning for a series of versions of a digital image. For example, the disclosed systems succinctly summarize multiple manipulations applied to a digital image in a sequence by processing the series of versions of the digital image utilizing deep learning. In some embodiments, the disclosed systems receive the series of versions of the digital image with a series of manipulations applied to the series of versions of the digital image and further accesses available edit descriptions that correspond to the series of manipulations. Further, in some embodiments, the disclosed systems utilize a large language model to generate a caption prediction that indicates a difference between a first version and a last version of the series of versions of the digital image.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

This disclosure will describe one or more embodiments of the invention with additional specificity and detail by referencing the accompanying figures. The following paragraphs briefly describe those figures, in which:

FIG. 1 illustrates an example environment in which an image difference captioning system operates in accordance with one or more implementations;

FIG. 2 illustrates an overview of the image difference captioning system generating a caption prediction from a series of versions of a digital image in accordance with one or more implementations;

FIG. 3 illustrates a diagram of a series of manipulations applied to a series of versions of a digital image in accordance with one or more implementations;

FIG. 4 illustrates a diagram of model architecture of the image difference captioning system in accordance with one or more implementations;

FIG. 5 illustrate a diagram of the image difference captioning system applying manipulations to a training digital image in accordance with one or more implementations;

FIG. 6 illustrates a diagram of the image difference captioning system utilizing a manipulation model to determine which manipulation to apply to a training digital image in accordance with one or more implementations;

FIG. 7 illustrates various examples of an inpainting manipulation, a property change manipulation, and a replacement manipulation applied to training digital images in accordance with one or more implementations;

FIG. 8 illustrates a diagram of the image difference captioning system performing a generative manipulation to a training digital image in accordance with one or more implementations;

FIG. 9 illustrates a diagram of the image difference captioning system providing a series of machine annotations and human annotations for training a model architecture to generate an image difference caption in accordance with one or more implementations;

FIG. 10 illustrates a diagram of the image difference captioning system training a large language mode based on a series of versions of a digital image in accordance with one or more implementations;

FIG. 11 illustrates a schematic diagram of the image difference captioning system in accordance with one or more implementations;

FIG. 12 illustrates a flowchart of a series of acts for generating a caption prediction that indicates a difference between a first version and a last version of a series of versions of a digital image in accordance with one or more implementations;

FIG. 13 illustrates a block diagram of an exemplary computing device in accordance with one or more implementations.

### DETAILED DESCRIPTION

One or more embodiments described herein include a deep-learning based image difference captioning system extracts the context of intermediate versions of the series of versions of the digital image to accurately generate an image difference caption between an earlier version (e.g., original or first version) and a later version (e.g., last version) of the digital image. Specifically, the image difference captioning system is able to simultaneously process multiple visual and textual inputs to provide a comprehensive evaluation of the visual and textual inputs via an image difference caption that summarizes differences between the earlier and later versions of the digital image. Additionally, in some embodiments, the image difference captioning system curates training datasets for training a large language model to generate image difference captions for long sequences of different versions of a digital image.

The image difference captioning system, in one or more implementations, utilizes an architecture that includes a vision transformer, various neural network layers, and a large language model. Specifically, the image difference captioning system utilizes the vision transformer to generate visual features from the series of versions of the digital image. Moreover, in some embodiments, the image difference captioning system utilizes a neural network layer (e.g., a concatenation layer) to combine the visual features and an additional neural network layer (e.g., a linear projection layer) to transform the visual features to be compatible with a large language model. Accordingly, the image difference captioning system processes the series of versions of the digital image by transforming the visual features of the series of versions of the digital image into text inputs compatible with the large language model.

In addition to the image difference captioning system generating text inputs from the series of versions of the digital image, the image difference captioning system also processes edit descriptions corresponding to the series of manipulations applied to the series of versions of the digital image. Specifically, the image difference captioning system accesses available edit descriptions (e.g., textual descriptions of changes applied to a digital image) and processes the edit descriptions along with the visual features transformed into text inputs.

In one or more embodiments, the image difference captioning system processes the text inputs (e.g., from the visual features and the edit descriptions) and generates a caption prediction. For instance, the caption prediction includes a textual description summarizing a difference between an earlier version (e.g., first version) and a latter version (e.g., last version) of a series of versions of a digital image. Moreover, the image difference captioning system draws from the context of the intermediate versions of the series of versions of the digital image to accurately generate the caption prediction, such that the caption prediction does not include irrelevant details not visible between the earlier and latter versions of the series of versions of the digital image.

As mentioned above, the image difference captioning system also curates a training dataset to utilize for training a large language model to generate an image difference caption from multiple inputs. Specifically, the image difference captioning system generates an image editing sequence dataset (e.g., a multiple edits and textual summaries dataset, hereinafter referred to as METS) that includes a dataset of image editing sequences, textual descriptions (e.g., machine annotations and human annotations), and binary masks of the manipulation regions at each step. For example, the image difference captioning system trains a model architecture of a large language model from the images within the image editing sequence dataset to process multiple visual and textual inputs and output a caption prediction.

As mentioned above, conventional systems suffer from a variety of problems with regard to computational accuracy and operational flexibility. For example, conventional systems suffer from computational accuracy in the context of content authenticity (e.g., transparency in an editing process and accurately detecting deep fake content for modified original content) and collaborative editing (e.g., multiple client devices involved in editing a digital image). Specifically, conventional systems are typically primed for generating captions based on training for image pairs. In doing so, conventional systems typically neglect to have a comprehensive understanding of image differences and fail to accurately convey content authenticity for more complex manipulations applied to content items. For instance, in the context of content authenticity and collaborative editing, conventional systems are typically limited to generating image captions between an image pair and thus generate inaccurate image captions for a series of edits applied to the same image.

In addition to conventional systems being trained on image pairs, conventional systems typically rely on pixel-level difference between input image pairs, rendering conventional systems hyper-sensitive to noise and geometric transformations. As such, conventional systems typically over-focus on irrelevant or unimportant descriptions of changes between an image pair. Moreover, some conventional systems attempt to correct for hyper-sensitivity to noise and geometric transformations by computing image differences at the semantic level, however these approaches primarily concentrate on the image modality which can also result in inaccurate captions. Thus, conventional systems typically fail to accurately have a holistic account of a series of manipulations applied to the same image.

Relatedly, conventional systems also suffer from operational flexibility. As mentioned, conventional systems are trained on image pairs. As a result, conventional systems cannot accurately extend to or adapt to content authenticity or collaborative editing processes that involve more than an image pair. Moreover, conventional systems struggle with generating image captions in a manner that effectively summarizes changes to a digital image.

In one or more embodiments, the image difference captioning system provides several improvements over conventional systems in relation to accuracy and operational flexibility for deep fake detection (e.g., modifications to original content item) to improve the integrity of image editing pipelines. For example, in some embodiments, the image difference captioning system improves upon computational accuracy. In particular, the image difference captioning system operates accurately in the context of content authenticity and collaborative editing because the image difference captioning system is trained on a series of versions of a digital image. In other words, the image difference captioning system is not restricted to accurately generating image difference captions for an image pair.

Specifically, the image difference captioning system contains a model architecture that processes a series of versions of a digital image with an applied series of manipulations to obtain a comprehensive understanding of image differences between a first and last version of a series of versions. For instance, the image difference captioning system accounts for the context of the intermediate versions of the series of versions to accurately generate a caption prediction. Moreover, at inference time, the image difference captioning system accurately ingests the series of versions of a digital image and generates an accurate image caption between a first and last version of the digital image (e.g., because the image difference captioning system is trained on a series of versions of a digital image).

As mentioned above, conventional systems typically hyper-focus on irrelevant or unimportant changes (e.g., either by being hyper-sensitive to pixel-level changes and/or primarily concentrating on the image modality). In contrast, the image difference captioning system accesses a series of versions of a digital image, generates text inputs from the series of versions of a digital image, and edit descriptions (e.g., textual inputs) to generate an accurate caption prediction. In doing so, the image difference captioning system considers the intermediate versions of the series of versions when generating a caption prediction between a first and last version (e.g., the image difference captioning system avoids hyper-focusing on irrelevant or unimportant changes and generates accurate and comprehensible caption predictions).

Moreover, the image difference captioning system further integrates both the textual and visual component to generate a caption prediction. For instance, the image difference captioning system generates text inputs from visual features of the series of versions of the digital image (e.g., such that the visual features are compatible with the embedding space of the large language model), and further processes edit descriptions of manipulations applied to the series of versions of the digital image. In doing so, the image difference captioning system draws from the image and text modality to accurately generate caption predictions and detect subtle or “deep fake” modifications applied to an image.

Relatedly, the image difference captioning system further improves upon operational flexibility. For example, the image difference captioning system extends the capability of image difference caption generation to a series of versions of a digital image (e.g., more than two versions of a digital image). Specifically, the image difference captioning system trains a model architecture on more than just image pairs. For instance, the image difference captioning system generates an image editing sequence dataset that includes versions of a training digital image, binary masks, and annotations. By using the training digital image, the image difference captioning system modifies parameters of a large language model to generate caption predictions more accurately between a first version and a last version of a series of versions of a digital image. Thus, the image difference captioning system more flexibly adapts to different use cases in generating an image caption (e.g., for deep fake detection).

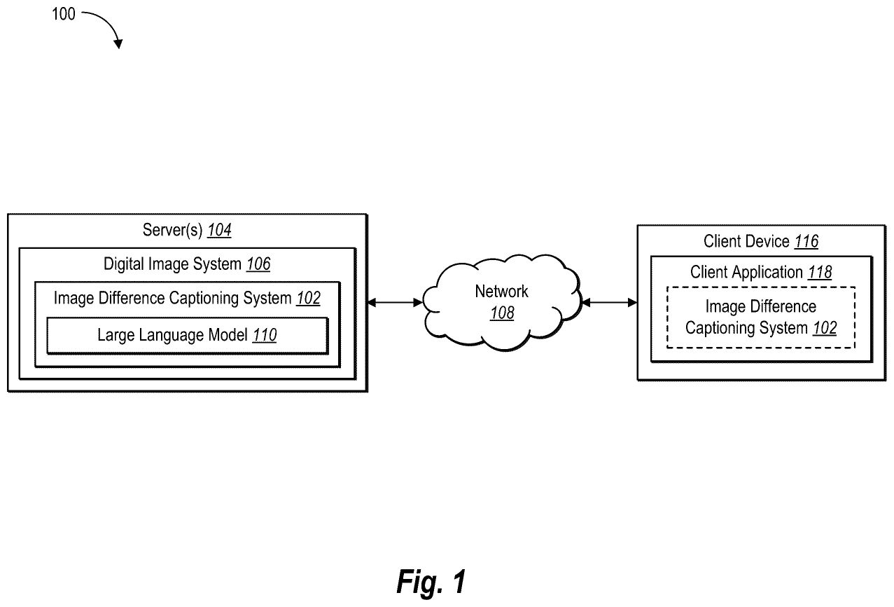

Additional details regarding the referring expression segmentation system will now be provided with reference to the figures. For example, FIG. 1 illustrates a schematic diagram of an exemplary system environment 100 in which an image difference captioning system 102 operates. As illustrated in FIG. 1, the system environment 100 includes server(s) 104, a digital image system 106, a network 108, and a client device 116. Additionally, FIG. 1 illustrates that the digital image system 106 includes the image difference captioning system 102 and the image difference captioning system 102 further includes a large language model 110. Moreover, the client device 116 includes a client application 118.

Although the system environment 100 of FIG. 1 is depicted as having a particular number of components, the system environment 100 is capable of having a different number of additional or alternative components (e.g., a different number of servers, client devices, or other components in communication with the image difference captioning system 102 via the network 108). Similarly, although FIG. 1 illustrates a particular arrangement of the server(s) 104, the network 108, and the client device 116, various additional arrangements are possible.

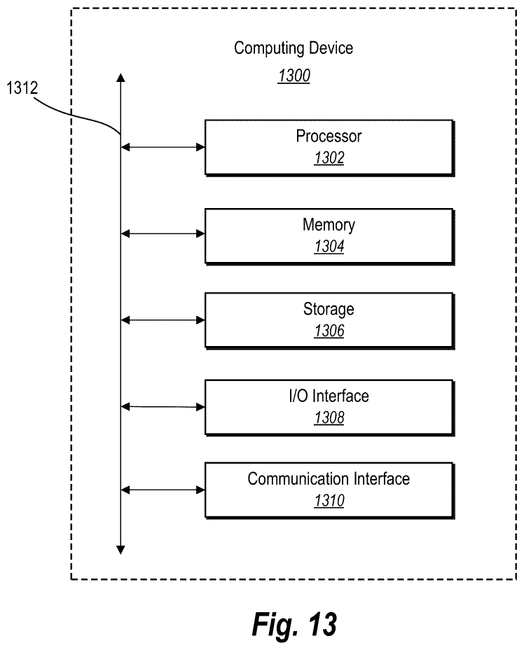

The server(s) 104, the network 108, and the client device 116 are communicatively coupled with each other either directly or indirectly (e.g., through the network 108 discussed in greater detail below in relation to FIG. 13). Moreover, the server(s) 104 and the client device 116 include one or more of a variety of computing devices (including one or more computing devices as discussed in greater detail in relation to FIG. 13).

As mentioned above, the system environment 100 includes the server(s) 104. In one or more embodiments, the server(s) 104 process input for an image difference captioning request or for an upload of a digital image that can include a series of versions of the digital image. In one or more embodiments, the server(s) 104 comprise a data server. In some implementations, the server(s) 104 comprise a communication server or a web-hosting server.

In some embodiments, the client device 116 includes computing devices associated with the one or more user accounts that submit image difference captioning requests and digital images for the image difference captioning system 102 to generate a caption prediction (e.g., an image difference caption). For instance, the image difference captioning system 102 trains one or more models (e.g., the large language model 110) from training datasets (e.g., METS) curated by the image difference captioning system 102 that includes various training digital images, annotations, and binary masks.

In one or more embodiments, the client device 116 includes smartphones, tablets, desktop computers, laptop computers, head-mounted-display devices, or other electronic devices. The client device 116 includes one or more software applications (e.g., the client application 118 includes a digital image editing application) for generating a caption prediction in accordance with the digital image system 106. In one or more embodiments, the client application 118 includes a software application hosted on the server(s) 104 accessible by the client device 116 through another application, such as a web browser.

To provide an example implementation, in some embodiments, the image difference captioning system 102 on the server(s) 104 supports the image difference captioning system 102 on the client device 116. For instance, in some cases, the digital image system 106 on the server(s) 104 gathers data for the image difference captioning system 102. In response, the image difference captioning system 102, via the server(s) 104, provides the information to the client device 116. In other words, the client device 116 obtains (e.g., downloads) the image difference captioning system 102 from the server(s) 104. Once downloaded, the image difference captioning system 102 on the client device 116 provides tools for indicating an image difference caption request between a series of versions of a digital image.

In alternative implementations, the image difference captioning system 102 includes a web hosting application that allows the client device 116 to interact with content and services hosted on the server(s) 104. To illustrate, in one or more implementations, the client device 116 access a software application supported by the server(s) 104. In response, the image difference captioning system 102 on the server(s) 104 provides tools for selecting a digital image or a specific version of a digital image to generate a caption prediction.

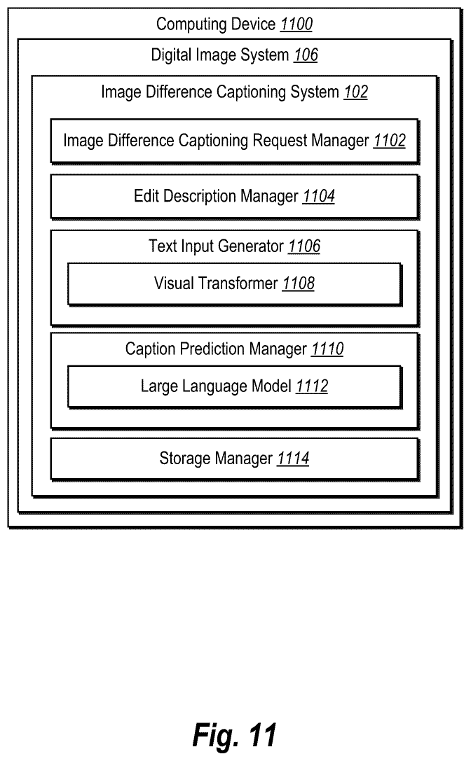

Indeed, in some embodiments, the image difference captioning system 102 is implemented in whole, or in part, by the individual elements of the system environment 100. For instance, although FIG. 1 illustrates the image difference captioning system 102 implemented or hosted on the server(s) 104, different components of the image difference captioning system 102 are able to be implemented by a variety of devices within the system environment 100. For example, one or more (or all) components of the image difference captioning system 102 are implemented by a different computing device or a separate server from the server(s) 104. Indeed, as shown in FIG. 1, the client device 116 includes the image difference captioning system 102. Example components of the image difference captioning system 102 will be described below with regard to FIG. 11.

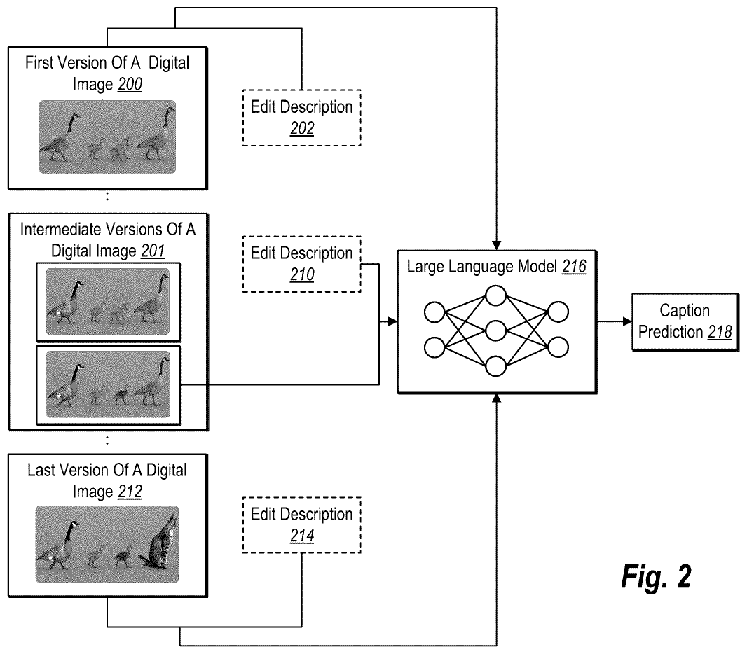

As mentioned above, FIG. 2 illustrates an overview of the image difference captioning system 102 utilizing a large language model to generate a caption prediction from a series of versions of a digital image in accordance with one or more embodiments. FIG. 2 shows the image difference captioning system 102 processing a series of versions of a digital image. For example, a digital image includes various pictorial elements. In particular, the pictorial elements include pixel values that define the spatial and visual aspects of the digital image such as text and image objects. For instance, the image difference captioning system 102 receives a digital image with various pixel-level properties (e.g., lightness, saturation, contrast, etc.) and various high-level properties (e.g., illustrated concepts, scenery, background, foreground, etc.). Specifically, the image difference captioning system 102 receives a digital image that had previously been edited by one or more client devices (e.g., the one or more client devices applied one or more manipulations to the digital image).

As mentioned, in some embodiments, the image difference captioning system 102 receives series of versions a digital image (e.g., with multiple manipulations applied to the digital image). For example, a series of versions of a digital image refers to multiple iterations of a digital image. Specifically, the series of versions of the digital image includes a single digital image with multiple manipulations applied to the digital image by one or more computing devices. To illustrate, the series of versions of the digital image includes a first version with a pixel-level manipulation (e.g., adjusted saturation) applied to the digital image, a second version with another pixel-level manipulation (e.g., adjusted brightness), a third version with an object removed from the digital image, and a fourth version with an object added to the digital image. In other words, the series of versions of the digital image refers to sequential versions of the digital image, where the sequence of versions is as a result of one or more manipulations applied to the digital image at different times.

As shown in FIG. 2, the image difference captioning system 102 receives a first version 200 of a digital image. For example, the first version 200 of the digital image refers to a starting point of a series of versions of the digital image. Specifically, in one or more implementations, the first version of the digital image includes an original digital image with various pictorial elements (e.g., objects, colors, background, foreground, etc.) and starting properties. In alternative implementations, the first version is not an original digital image but rather the earliest version being analyzed. Moreover, subsequent manipulations applied to the first version 200 of the digital image results in subsequent versions of the digital image (e.g., intermediate versions and/or the last version).

Moreover, FIG. 2 also shows intermediate versions 201 of the digital image. For example, an intermediate version of the digital image refers to a version between a first version and a last version of the digital image. Specifically, in some embodiments, the series of versions of the digital image includes one or more intermediate versions of the digital image (e.g., for a series of five versions, the intermediate versions include versions two to four).

In addition, FIG. 2 also shows a last version 212 of the digital image. For example, a last version of the digital image refers to an ending point of a series of versions of the digital image being analyzed. Specifically, the last version of the digital image includes a last iteration of the digital image up to a current point in time being analyzed. For instance, a series of versions of the digital image includes five versions (e.g., due to five separate manipulations applied to the digital image) and the last version refers to the fifth version of the series of versions of the digital image. In one or more implementation, the series of versions of the digital image includes later versions after the last version that are not being analyzed in a given caption generation process, and thus, are not considered the last version for the given operation. Thus, the last version, in one or more implementations, comprises an intermediate version selected to be utilized as a final image in an image captioning operation (e.g., a user selects a first and last image in a series of image for which they want a caption indicating differences therebetween).

As illustrated in FIG. 2, in some embodiments, the image difference captioning system 102 also processes edit descriptions corresponding to versions of a series of versions of the digital image. For example, an edit description refers to a textual description of one or more manipulations applied to a version of a digital image. Specifically, the edit description includes a manipulation, or a set of manipulations applied to a specific version of the digital image of the series of versions of the digital image. For instance, the edit description includes a metadata tag that corresponds to a version of a digital image that includes parameters of the manipulation, a type of manipulation. In some instances, the metadata tag of the edit description also includes a binary mask that identifies an area/object where one or more pixels were manipulated in the version of the digital image.

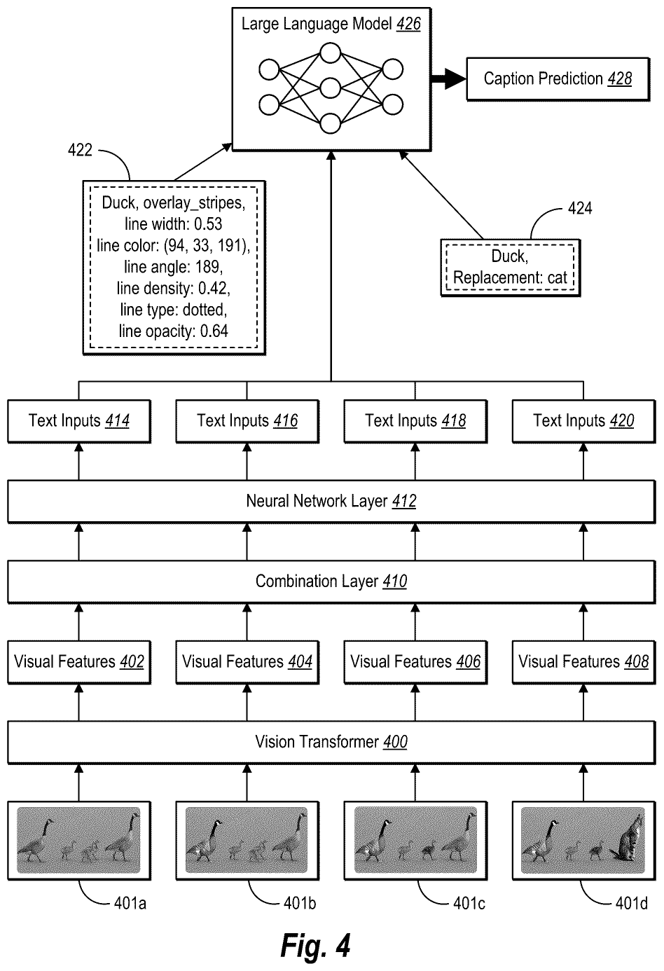

To illustrate, FIG. 2 shows an edit description 202 that optionally accompanies the first version 200 of the digital image, an edit description 210 that optionally accompanies the intermediate versions 201 of the digital image, and an edit description 214 that optionally accompanies the last version 212 of the digital image. Additional details regarding the edit description are provided below in the description of FIGS. 4, 9, and 10.

As shown, the image difference captioning system 102 utilizes a machine learning model (e.g., large language model 216) to process a series of versions of the digital image, and in some embodiments, the large language model 216 also processes the edit descriptions. For example, the large language model 216 includes or refers to one or more neural networks capable of processing natural language text to generate outputs that range from predictive outputs, analyses, or combinations of data within stored content items. In particular, the large language model 216 include parameters trained (e.g., via deep learning) on large amounts of data to learn patterns and rules of language for summarizing and/or generating digital content.

A machine learning model includes a computer representation that is tunable (e.g., trained) based on inputs to approximate unknown functions used for generating corresponding outputs. In particular, in one or more embodiments, a machine learning model is a computer-implemented model that utilizes algorithms to learn from, and make predictions on, known data by analyzing the known data to learn to generate outputs that reflect patterns and attributes of the known data. For instance, in some cases, a machine learning model includes, but is not limited to, a neural network (e.g., a convolutional neural network, recurrent neural network, or other deep learning network), a decision tree (e.g., a gradient boosted decision tree), support vector learning, Bayesian networks, a transformer-based model, a diffusion model, or a combination thereof.

Similarly, a neural network includes a machine learning model that is trainable and/or tunable based on inputs to determine classifications and/or scores, or to approximate unknown functions. For example, in some cases, a neural network includes a model of interconnected artificial neurons (e.g., organized in layers) that communicate and learn to approximate complex functions and generate outputs based on inputs provided to the neural network. In some cases, a neural network refers to an algorithm (or set of algorithms) that implements deep learning techniques to model high-level abstractions in data. A neural network includes various layers such as an input layer, one or more hidden layers, and an output layer that each perform tasks for processing data. For example, a neural network includes a deep neural network, a convolutional neural network, a diffusion neural network, a recurrent neural network (e.g., an LSTM), a graph neural network, a transformer, or a generative adversarial neural network.

A large language model refers to artificial intelligence models capable of processing and generating natural language text. In particular, language machine learning models are trained on large amounts of data to learn patterns and rules of language. As such, language machine learning model post-training are capable of generating output predictions that indicate visualization structures. Further, in some embodiments, the language machine learning model includes or refers to one or more transformer-based neural networks capable of processing natural language text to generate outputs that range from predictive outputs, analyses, or combinations of data within stored content items (e.g., large language models and language transformer models). In particular, a language machine learning model includes parameters trained (e.g., via deep learning) on large amounts of data to learn patterns and rules of language for summarizing and/or generating digital content. Examples of language machine learning models include BLOOM, Bard AI, ChatGPT, LaMDA, DialoGPT.

As shown, the image difference captioning system 102 utilizes the large language model 216 to generate a caption prediction 218 from the series of versions of the digital image. As mentioned above, the image difference captioning system 102 processes the context of the intermediate versions 201 of the digital image to obtain a comprehensive (or more comprehensive) understanding of the series of versions of the digital image to accurately generate the caption prediction 218.

For example, the image difference captioning system 102 processes the intermediate versions 201 of the digital image to understand the manipulated/modified visual features of the intermediate versions relative to the first version 200 and the last version 212 of the digital image. Specifically, the image difference captioning system 102 processes the context of the intermediate versions 201 of the digital image to understand which objects were removed, added, and/or replaced which properties of objects were modified/manipulated, and which pixel-level properties were manipulated. From processing this context, the image difference captioning system 102 more accurately generates an image difference caption between the first version 200 of the digital image and the last version 212 of the digital image.

In one or more embodiments, the caption prediction 218 refers to the image difference captioning system 102 generating a textual prediction of a difference between the first version 200 of the digital image and the last version 212 of the digital image of a series of versions of the digital image. Specifically, the caption prediction 218 includes an image comparison task of how or what has changed between the first version 200 and the last version 212 of the digital image. To illustrate, the caption prediction 218 includes “two geese are missing, and one is replaced with a cat.”

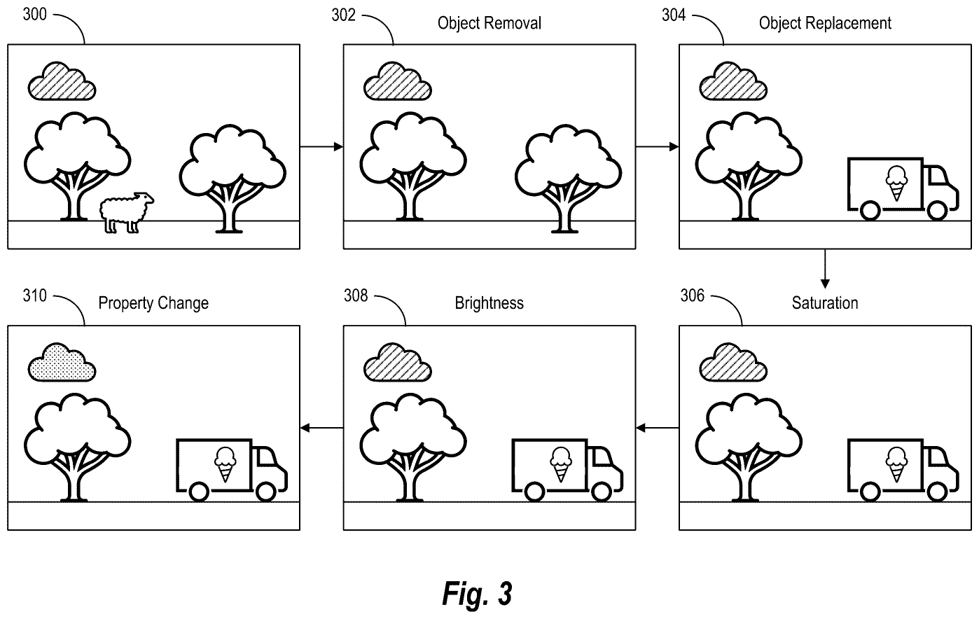

As mentioned above, the image difference captioning system 102 receives a digital image with a series of manipulations applied to the digital image. FIG. 3 illustrates an example diagram of a series of manipulations applied to a digital image in accordance with one or more embodiments. For example, a series of manipulations refers to multiple manipulations applied to the series of versions of the digital image. Specifically, in some embodiments, a series of manipulations refers to a single manipulation applied to a first version of the digital image and an additional single manipulation applied to a second version of the digital image. For instance, for a series of five versions of the digital image, the series of five versions includes five manipulations applied in a series to the digital image (e.g., original, pixel-level manipulation, object added, object removed, pixel-level manipulation). In some embodiments, the series of manipulations includes multiple sets of manipulations applied to the digital image. For instance, a first computing device applies a first set of manipulations to the digital image (e.g., a first version of the digital image with a pixel-level manipulation, an object added, and an object removed), a second computing devices applies a second set of manipulations to the digital image (e.g., a pixel-level manipulation and a property change) and a third computing device applies a third set of manipulations to the digital image (e.g. pixel-level manipulation).

As shown in FIG. 3, the image difference captioning system 102 accesses/receives a digital image with a series of manipulations or in some embodiments, the image difference captioning system 102 applies the manipulations to the digital image. FIG. 3 is described in terms of the image difference captioning system 102 performing acts of manipulation to a digital image, however, these acts can be performed prior to the image difference captioning system 102 receiving the digital image.

For instance, FIG. 3 shows the image difference captioning system 102 receiving a first version 300 of the digital image with a cloud (e.g., that has a specific striped pattern), two trees, and a sheep. Furthermore, FIG. 3 shows a second version 302 of the digital image. Specifically, the second version 302 of the digital image includes the image difference captioning system 102 applying a manipulation applied to the first version 300 of the digital image. For instance, the image difference captioning system 102 applies a manipulation of object removal that results in the second version 302 of the digital image.

For example, object removal refers to the image difference captioning system 102 identifying an object (e.g., via a corresponding object mask) and removing the object from the digital image. Specifically, the image difference captioning system 102 removes pixels from the digital image that correspond to an object selected for removal. For instance, the image difference captioning system 102 utilizes a generative inpainting model to remove pixels from the first version 300 of the digital image and generate a content fill (e.g., to naturally replace the removed object with pixels that are consistent with the rest of the digital image) to replace the removed pixels.

FIG. 3 further shows the image difference captioning system 102 applying a second manipulation to generate a third version 304 of the digital image. Specifically, FIG. 3 shows the image difference captioning system 102 applying an object replacement manipulation to the second version 302 of the digital image to generate the third version 304 of the digital image.

In one or more embodiments, object replacement refers to the image difference captioning system 102 identifying an object within the digital image, removing the identified object, and adding a new object in place of the removed identified object. Specifically, the image difference captioning system 102 utilizes a generative inpainting model to remove and replace the object with a new object.

In addition to object replacement, in some embodiments, the image difference captioning system 102 performs object addition. Similar to object replacement, object addition refers to the image difference captioning system 102 inserting an object into the digital image. Specifically, the image difference captioning system 102 generates pixels corresponding to a “new object” into the digital image. For instance, the image difference captioning system 102 utilizes a generative model to generate the pixels corresponding to the new object.

As further shown in FIG. 3, the image difference captioning system 102 generates a fourth version 306 and a fifth version 308 of the digital image from applying pixel-level modifications to the digital image. For example, a pixel-level modification refers to changes to the digital image that consume a smaller number of computational resources (e.g., relative to generative manipulations such as replacing an object, adding an object, or removing an object). Specifically, the pixel-level modification includes modifying brightness, contrast, saturation, encoding quality changes, blur, noise, sharpness filters, overlaying patterns with the colors (e.g., with different widths), and applying a blur filter. For instance, FIG. 3 shows the image difference captioning system 102 generating the fourth version 306 of the digital image by changing the saturation of the digital image. Moreover, FIG. 3 shows the image difference captioning system 102 generating the fifth version 308 of the digital image by changing the brightness of the digital image.

Lastly, FIG. 3 shows the image difference captioning system 102 generating a sixth version 310 of the digital image. Specifically, the sixth version 310 of the digital image includes the image difference captioning system 102 applying a property change manipulation to the fifth version 308 of the digital image. For example, a property change refers to the image difference captioning system 102 modifying material properties of a digital image. Specifically, the property change includes the image difference captioning system 102 changing the striped cloud pattern to a dotted cloud pattern.

As illustrated, FIG. 4 shows an example diagram of model architecture utilized by the image difference captioning system 102 to generate a caption prediction from a series of versions of a digital image in accordance with one or more embodiments. For example, FIG. 4 shows the image difference captioning system 102 processing a series of versions of a digital image 401a-401d by utilizing a vision transformer 400.

In one or more embodiments, the vision transformer 400 includes a model for understanding and analyzing visual information. Specifically, the vision transformer 400 refers to a neural network specifically designed for computer vision tasks with self-attention and feedforward neural networks. For instance, the image difference captioning system 102 utilizes the vision transformer 400 to break down an input image into smaller fixed-size patches and embeds the image patches into image vectors. For example, the image difference captioning system 102 via the vision transformer extracts information from visual data with natural language processing techniques and can generate textual information from the extracted visual data. In particular, in one or more embodiments, the vision transformer 400 includes multiple layers (e.g., a combination neural network layer and a linear projection layer) to transform the visual features obtained from a digital image into an input compatible with the embedding space of a large language model.

In one or more embodiments, the vision transformer 400 includes an image encoder to extract features from the series of versions of the digital image 401a-401d. For example, an image encoder is a neural network (or one or more layers of a neural network) that extract features relating to a version of a digital image (e.g., localized features or global features of the digital image). In some cases, an image encoder refers to a neural network that both extracts and encodes features from a digital image. For example, an image encoder can include a particular number of layers including one or more fully connected and/or partially connected layers of neurons that extract image patches from the digital image and encode localized and/or global features of the digital image. To illustrate, in one or more embodiments, the image difference captioning system 102 generates image patch feature representations that represent patches from a digital image.

In one or more embodiments, the image difference captioning system 102 extracts image patches from a digital image. In particular, image patches include sub-dividing a digital image into smaller regions. For instance, the image difference captioning system 102 sub-divides the digital image into patches, where each patch represents localized regions within the digital image. Furthermore, in one or more embodiments, an image patch does not share any pixel values with other image patches. In some embodiments, an image patch overlaps with pixel values of an adjacent image patch. Accordingly, in one or more embodiments, the image difference captioning system 102 sub-divides a digital image into image patches where some of the image patches do not overlap with pixel values of other image patches and some of the image patches do overlap with pixel values of other image patches.

In one or more embodiments, the image difference captioning system 102 extracts image patches and generates visual features 402-408 (e.g., image patch feature representations). In particular, the image difference captioning system 102 utilizes an image encoder to generate the visual features 402-408. For instance, the visual features 402-408 each correspond with a group of image patches and represents the visual features within the series of versions of the digital image 401a-401d. Further, in one or more embodiments, the visual features 402-408 includes both a vector embedding and a token representation.

For example, the image difference captioning system 102 represents image content as a sequence of visual tokens. Specifically, the image difference captioning system 102 converts each patch of an input image into a high-dimensional vector representation and further encodes positional data to provide information about a relative position of an image patch within the digital image (e.g., this captures spatial relationships between different patches).

As shown in FIG. 4, the image difference captioning system 102 generates visual features 402 corresponding to a first version 401a, visual features 404 corresponding to a second version 401b, visual features 406 corresponding to a third version 401c, and visual features 408 corresponding to a fourth version 401d. As mentioned above, the visual features 402 include a vector embedding. In one or more embodiments, the image difference captioning system 102 generates image patch feature vectors by utilizing an image encoder. In particular, the image difference captioning system 102 generates the image patch feature vectors based on the extracted image patches from the series of versions of the digital image 401a-401d. For instance, the image patch feature vectors represent elements from the image patches. The image patch feature vectors represent the image patches as a vector or a set of vectors in a lower-dimensional space.

As shown, the image difference captioning system 102 utilizes various neural network layers that include a combination layer 410. For example, the combination layer 410 refers to a layer of a neural network that combines multiple features (e.g., visual features) into a single tensor (e.g., vector). Specifically, the image difference captioning system 102 utilizes the combination layer 410 to concatenate multiple visual features (e.g., that are made up of visual tokens) from the digital image into a single tensor. For instance, the image difference captioning system 102 concatenates visual tokens of the visual features 402 into groups of four.

As shown, the architecture further includes a neural network layer 412. Specifically, the neural network layer 412 includes a linear projection layer or a multi-layer perceptron. For example, the image difference captioning system 102 utilizes the neural network layer 412 for transforming combined visual features (e.g., the concatenated visual tokens) to be compatible with an embedding space of large language model 426.

In one or more embodiments, a linear projection layer refers to a component of a neural network architecture for transforming input data from a first dimensional space to a second dimensional space. For instance, the image difference captioning system 102 utilizes the linear projection layer to map input features to a different set of output features. In some embodiments, the image difference captioning system 102 utilizes the linear projection layer to map visual features to textual inputs (e.g., for the large language model 426).

In one or more embodiments, a multi-layer perceptron (hereinafter referred to as “MLP”) refers to a feedforward artificial neural network with multiple layers of interconnected nodes organized in a sequential manner. Specifically, the MLP includes an input layer, multiple hidden layers, and an output layer. Moreover, each neuron in one layer of the MLP is fully connected to every neuron of a subsequent layer. In some embodiments, the image difference captioning system 102 utilizes the MLP to transform the visual features to textual inputs (e.g., for the large language model).

In one or more embodiments, an embedding space refers to a mathematical space in which objects (e.g., words, images, or other data points) are represented as vectors with numerical values. Specifically, in an embedding space, each object is represented by a vector that corresponds to a specific feature or attribute of an object. For instance, a high-dimensional embedding space captures more complex relationships and indicates a number of features used to represent each object. Moreover, in an embedding space, the distance between objects represents the similarity or dissimilarity of objects.

As shown in FIG. 4, the image difference captioning system 102 uses the neural network layer 412 to generate text inputs 414-420 from the visual features 402-408. For instance, text inputs 414 corresponds to visual features 402, text inputs 416 corresponds to visual features 404, text inputs 418 corresponds to visual features 406, and text inputs 420 corresponds to visual features 408.

For example, a text input refers to a textual prompt, question, or command. Specifically, the image difference captioning system 102 generates text tokens from the text input by breaking down the text input into smaller units (e.g., words, sub-words, or characters) and maps each token to a defined index. Moreover, the image difference captioning system 102 converts the text tokens into a numerical form for processing by the large language model 426. Thus, the image difference captioning system 102 utilizes the large language model 426 to process the text inputs and generate an image difference caption.

As further shown, the image difference captioning system 102 feeds the text inputs 414-420 from the visual features 402-408 into the large language model 426. Additionally, FIG. 4 shows the image difference captioning system 102 utilizing the large language model 426 processing a first edit description 422 and a second edit description 424. In one or more embodiments, the edit description includes a type of manipulation and/or parameters of the manipulation. Further, the image difference captioning system 102 processes the edit descriptions as text inputs (e.g., similar to the text inputs 414-420 from the visual features 402-408).

In one or more embodiments, a type of manipulation refers to a pixel-level manipulation (e.g., brightness, saturation, contrast, filters, etc.) or a generative manipulation (e.g., object removal, object addition, or object replacement). Moreover, parameters of the manipulation refer to specific settings or values of a version of a digital image. Specifically, the parameters of the manipulation include pixel coordinates within a version of the digital image where a manipulation was applied to the digital image. Furthermore, the parameters of the manipulation also include a degree or level of modification applied to a version of the digital image (e.g., overall brightness or contrast settings).

As shown, the image difference captioning system 102 utilizes the large language model 426 to process the first edit description 422, the second edit description 424, and the text inputs 414-420 to generate a caption prediction 428. In one or more embodiments, the image difference captioning system 102 utilizes a text encoder of the large language model 426 to process the edit descriptions and text inputs. In particular, the text encoder includes a component of a neural network to transform textual data into a numerical representation. For instance, the image difference captioning system 102 utilizes the text encoder to transform text tokens into a text vector representation.

In one or more embodiments, the image difference captioning system 102 generates the caption prediction 428 in response to an image difference captioning request. For example, the image difference captioning request refers to a request for a computing device to receive a textual description of a difference between versions of a digital image (e.g., the first version 401a and the fourth version 401d, also known as the last version). In some embodiments, the image difference captioning system 102 generates an image difference captioning request in response to receiving a digital image (e.g., generates an image difference caption based on identifying multiple versions of the received digital image). For instance, the image difference captioning system 102 generates the image difference captioning request in response to receiving a digital image to provide a content authenticity check or a collaboration history to a client device.

In some embodiments, the image difference captioning system 102 generates an image difference captioning request in response to receiving the request from the client device to generate the image difference caption. For instance, the image difference captioning system 102 receives an indication of the digital image that contains multiple versions, and the image difference captioning system 102 generates the image difference caption (e.g., between a first version and a last version).

Thus, as shown, the image difference captioning system 102 receives an image difference captioning request and utilizes the architecture shown in FIG. 4 to generate the caption prediction 428. To illustrate, the caption prediction 428 reads “one goose is replaced with a cat, one goose is removed, and another one is covered in purple patches.”

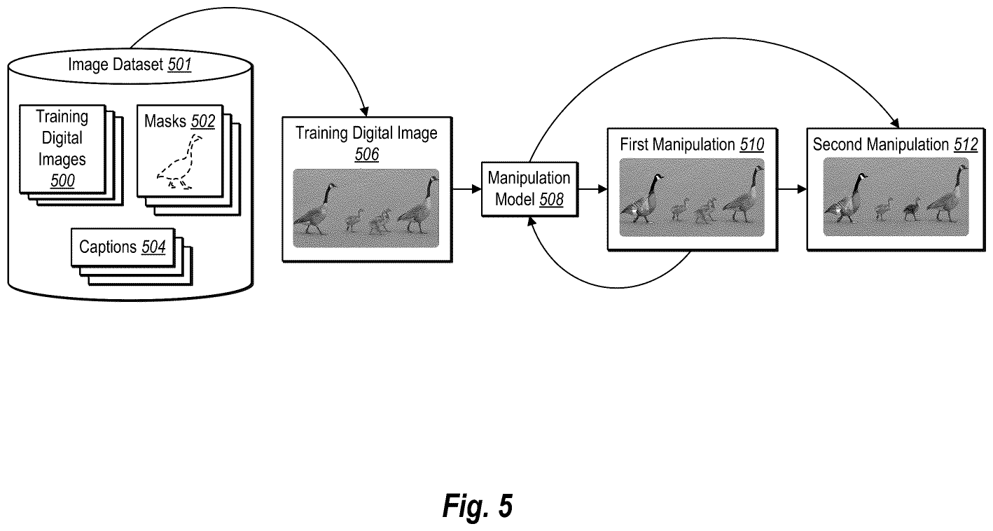

As mentioned above, the image difference captioning system 102 generates an image editing sequence dataset by applying manipulations to training digital images. FIG. 5 illustrates an example diagram of the image difference captioning system 102 applying a first and second manipulation to a training digital image in accordance with one or more embodiments.

As shown, the image difference captioning system 102 accesses an image dataset 501 that includes training digital images 500, masks 502, and captions 504 (e.g., annotations). For example, the masks 502 includes a binary mask which refers to a digital image where each pixel of the digital image is assigned either a 0 or a 1 (e.g., a black or white color). Specifically, the binary mask indicates which pixels belong to a specific object (1) and which pixels do not belong to the specific object (0). Further, the binary mask includes masking background pixels and highlighting foreground pixels (e.g., or vice-versa). In other words, image difference captioning system 102 utilizes the binary mask to identify a region of interest.

As shown, the image dataset 501 includes the training digital images 500. For example, a training digital image 506 refers to a digital image the that the image difference captioning system 102 utilizes to apply a series of manipulations for training a large language model. Specifically, the image difference captioning system 102 accesses the training digital image 506 from the image dataset 501 that contains corresponding binary masks for objects within the training digital image 506. For instance, the image difference captioning system 102 applies a first manipulation 510 to the training digital image 506 to create a first version of the training digital image 506. Moreover, the image difference captioning system 102 applies a second manipulation 512 to the training digital image 506 to create a second version of the training digital image 506. Additionally, in some embodiments, the image difference captioning system 102 applies a third, and fourth manipulation to the training digital image 506 to create a third and fourth version of the training digital image 506 (e.g., a series of versions of the digital image).

In some embodiments, the training digital image 506 includes a plurality of non-overlapping objects (e.g., separate discrete objects such as dogs, cats, birds, etc.). For example, non-overlapping binary masks refers to binary masks for non-overlapping objects. As mentioned, the image difference captioning system 102 utilizes the training digital image 506 with non-overlapping binary masks. Moreover, the image difference captioning system 102 applies one or more manipulations to a single object (e.g., corresponding to a binary mask) and then moves to another object (e.g., corresponding to another binary mask) and applies one or more additional manipulations.

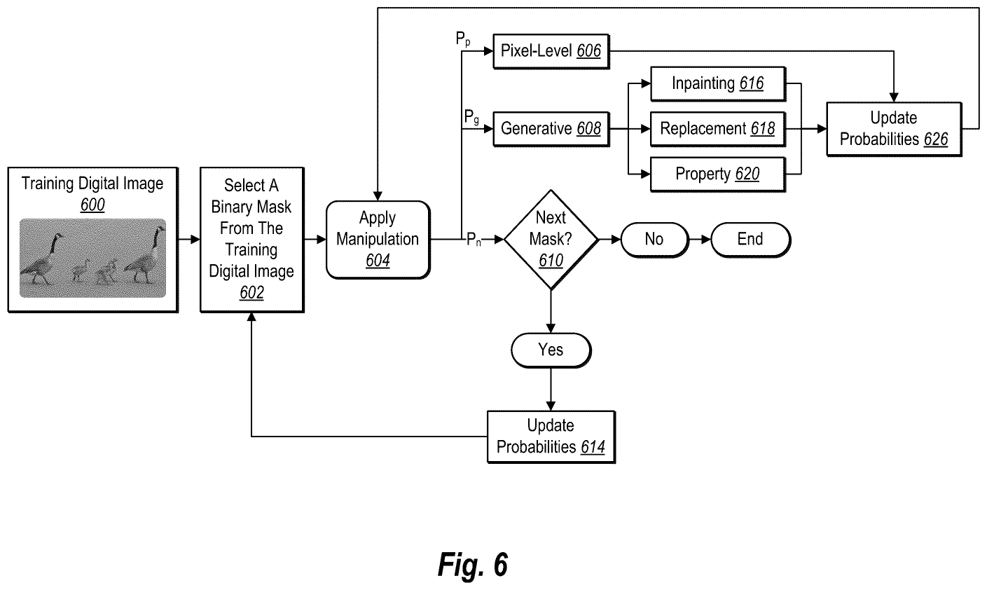

As shown, the image difference captioning system 102 accesses the training digital image 506 and further utilizes a manipulation model 508 to determine to apply a first manipulation and a second manipulation to the training digital image 506. For example, the manipulation model 508 refers to an algorithm or heuristic that the image difference captioning system 102 utilizes to determine a type of manipulation to apply to the training digital image 506. Specifically, the image difference captioning system 102 utilizes the manipulation model 508 which contains different probabilities assigned to different manipulations. For instance, the image difference captioning system 102 utilizes the manipulation model 508 to select a binary mask for a training digital image and then determines which manipulation to apply (e.g., pixel-level manipulation or a generative manipulation, etc.). Specific details of the manipulation model 508 are given below in the description of FIG. 6.

In one or more embodiments, the image difference captioning system 102 generates a plurality of series of versions of digital images (from images of the image dataset 501) and applies manipulations to the training digital images to generate an image editing sequence dataset. For example, an image editing sequence dataset refers to a training dataset containing multiple training digital images, a plurality of non-overlapping binary masks corresponding to the multiple training digital images, and annotations for manipulations applied to the training digital images. Specifically, the image difference captioning system 102 selects multiple training digital images from an image dataset, applies one or more manipulations to the training digital images (e.g., creates a sequence of versions of the training digital images) and stores the training digital images (e.g., with the manipulations, annotations, and binary masks) in an image editing sequence dataset. Moreover, the image difference captioning system 102 utilizes the image editing sequence dataset to generate predictions, determine a measure of loss, and modify parameters of the system architecture.

As mentioned above, FIG. 6 provides details regarding the image difference captioning system 102 utilizing a manipulation model. FIG. 6 illustrates the image difference captioning system 102 utilizing a manipulation model to determine which manipulation to apply to a training digital image in accordance with one or more embodiments.

As shown, the image difference captioning system 102 accesses a training digital image 600 (e.g., from an image dataset, such as the image dataset 501) and further accesses the non-overlapping binary masks corresponding to the training digital image. Specifically, the image difference captioning system 102 performs an act 602 of selecting a binary mask from the training digital image 600. For instance, the training digital image 600 shows a group of ducks, where each of the ducks have a corresponding binary mask. As such, the image difference captioning system 102 selects a binary mask that corresponds with one of the ducks shown in the training digital image 600.

Moreover, as shown, the image difference captioning system 102 performs an act 604 of applying a manipulation. As shown in FIG. 6, the image difference captioning system 102 performs the act 604 of applying a manipulation based on different probabilities assigned to different manipulations. Specifically, FIG. 6 shows a pixel-level manipulation 606 with a first assigned probability, a generative manipulation 608 with a second assigned probability and a third probability for an act 610 of transitioning to another binary mask of the training digital image 600. Furthermore, the generative manipulation 608 includes three sub-types of inpainting 616, replacement 618, and property 620.

As further shown in FIG. 6, in addition to applying one of the pixel-level manipulation 606 or the generative manipulation 608, the image difference captioning system 102 further performs an act 626 of updating the probabilities based on the applied manipulation. Moreover, after updating the probabilities, the image difference captioning system 102 iteratively performs the act 604 of applying a subsequent manipulation or transitioning to another binary mask of the training digital image 600.

As shown, for the act 610 of transitioning to another mask, the decision box indicates “no” which results in ending the manipulations applied to the training digital image 600. In contrast, for the act 610 of transitioning to another mask, the decision box indicates “yes” which results in the image difference captioning system 102 selecting another binary mask of the training digital image 600 and performing an act 614 of updating the probabilities of the applied manipulations.

In one or more embodiments, the image difference captioning system 102 chooses training digital images from the image dataset with at least five non-overlapping segmentation masks (e.g., binary masks). As described above, the image difference captioning system 102 then applies a sequence of edits to the training digital image with at least five non-overlapping segmentation masks. As already described, the image difference captioning system 102 selects a segmentation mask and either applies a generative manipulation, a pixel-level manipulation or moves on to another mask of the selected training digital image. Moreover, the probability of switching to another mask of the training digital image is proportional to the number of manipulations already applied to the segmentation mask.

To illustrate, the image difference captioning system 102 defines the probabilities of applying a generative manipulation (P_{g}), a pixel-level manipulation (Pₚ), and moving on to the next mask (Pₙ) as follows:

P_{g}=g−n/2,Pₚ=(1−g)−n/2,Pₙ=1−P_{g}−Pₚ

In the above notation, g=0.9 if no generative manipulations have been applied to the mask of the training digital image 600 and g=0.1 if a generative manipulation has been applied to the mask of the training digital image 600.

Moreover, the value of n is proportional to the number of manipulations already applied to the mask, defined as follows:

n=max(0,40×(i−iₘᵢₙ)/100)

In the above notation, I is the current step and iₘᵢₙ refers to the minimum number of steps required to move on to the next mask of the training digital image 600. For instance, in some embodiments, the image difference captioning system 102 sets iₘᵢₙ to five.

In one or more embodiments, after each manipulation step, the image difference captioning system 102 records the type of manipulation, the parameters of the manipulation, and the binary mask used to apply the manipulation. Specifically, the image difference captioning system 102 saves the recorded information (e.g., in text form) in a data storage location. To illustrate, for the pixel-level manipulations 606, the image difference captioning system 102 utilizes a text format as follows:
Object: obj_name, manipulation: edit_name, intensity: intensity
   In the above text format notation, obj_name is the name of the object as annotated within the image dataset, edit_name is the manipulation type, and intensity is chosen at random from a set of predefined parameters (e.g., individual for each manipulation type, in other words, a pixel-level manipulation for brightness has a preset intensity).

To further illustrate, for the generative manipulations 608, the image difference captioning system 102 utilizes a text format as follows:
Object: obj_name, replacement: prompt
   In the above notation, prompt is either background for inpainting 616 or the output of a large language model for replacement 618 and property 620 change manipulations.

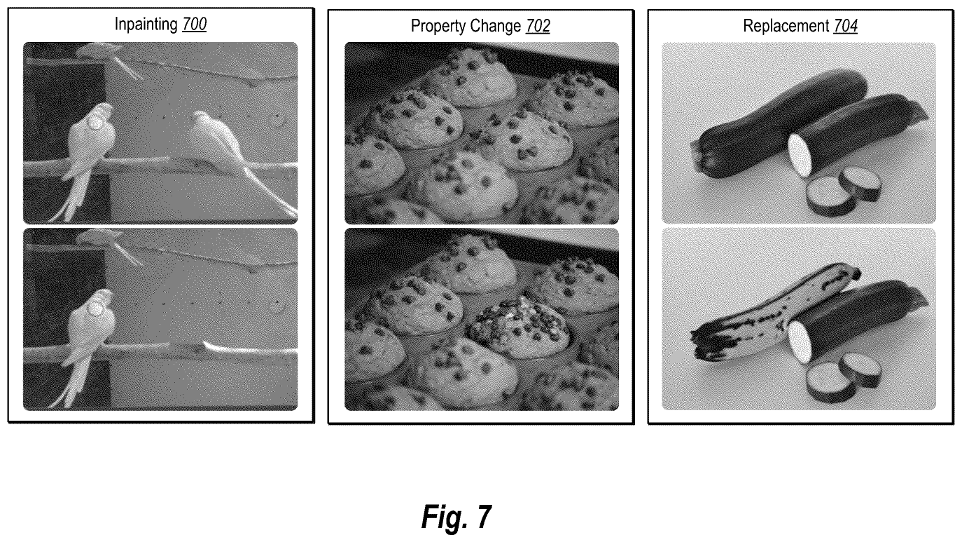

FIG. 7 provides additional examples of an inpainting manipulation, a property change manipulation, and a replacement manipulation applied to training digital images in accordance with one or more embodiments. For example, FIG. 7 shows an inpainting manipulation 700 where the top digital image shows three birds, and the bottom image shows one of the birds removed and the background inpainted to be consistent with the rest of the digital image.

Furthermore, FIG. 7 shows a property change manipulation 702 with the top image showing multiple muffins with chocolate chips and the bottom image with one of the muffins with chocolate chips replaced with rainbow-colored toppings. Additionally, FIG. 7 shows a replacement manipulation 704 with the top image showing a couple of zucchinis and the bottom digital image showing one of the zucchinis replaced with a banana.

To illustrate, the image difference captioning system 102 performs the pixel-level manipulations utilizing an image augmentation library, with a random choice of augmentation type and parameters. As previously mentioned, the image augmentation library includes augmentations such as changes to brightness, contrast, saturation, encoding quality changes, blur, noise, sharpness filters, and overlaying random stripes of a specific color or different widths. Moreover, the image difference captioning system 102 performs the generative manipulations by utilizing various generative adversarial neural networks and inpainting models (e.g., language-guided models).

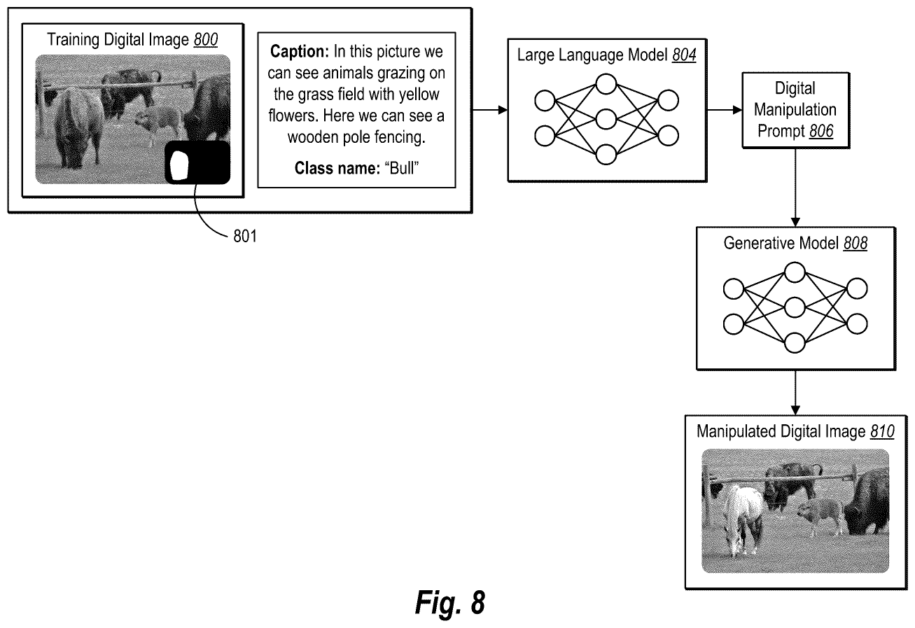

FIG. 8 illustrates an example diagram of the image difference captioning system 102 applying a generative manipulation to a training digital image in accordance with one or more embodiments. For example, the image difference captioning system 102 accesses training digital image 800 from an image dataset. As further shown, the image difference captioning system 102 also accesses a segmentation mask 801 that corresponds with the training digital image 800 (e.g., the segmentation mask 801 corresponds to the bull on the left). In some embodiments, the image difference captioning system 102 generates a convex hull of the segmentation mask 801 and applies a dilation to the segmentation mask 801 to ensure that no part of the object remains outside of the segmentation mask 801.

As shown in FIG. 8, the image difference captioning system 102 determines to apply a generative manipulation to the training digital image 800. As shown, the training digital image 800 contains a caption of “in this picture we can see animals grazing on the grass field with yellow flowers. Here we can see a wooden pole fencing.” Moreover, the training digital image 800 further contains a class name of “bull.” Furthermore, the image difference captioning system 102 sends the training digital image 800 along with the caption and the class name to the large language model. Specifically, the image difference captioning system 102 utilizes the large language model 804 to generate a digital manipulation prompt 806. For instance, the digital manipulation prompt 806 includes a prompt provided to a generative model 808.

As shown, the image difference captioning system 102 utilizes the generative model 808 to generate a manipulated digital image 810. Specifically, the image difference captioning system 102 generates the manipulated digital image 810 that includes a bull from the training digital image 800 replaced with a white horse.

FIG. 8 shows the image difference captioning system 102 using the large language model 804 for generating prompts related to generative manipulations. In some embodiments, the image difference captioning system 102 utilizes the large language model 804 to generate prompts for both pixel-level manipulations and generative manipulations. In one or more embodiments, for a property change manipulation, the image difference captioning system 102 utilizes a prompt (e.g., to provide to the large language model 804) with a localized narrative for the training digital image 800, a bounding box of the mask, and a class label to come up with a probable replacement property. Moreover, in one or more embodiments, for inpainting manipulations, the image difference captioning system 102 utilizes the word “background” as part of the prompt to the generative model 808.

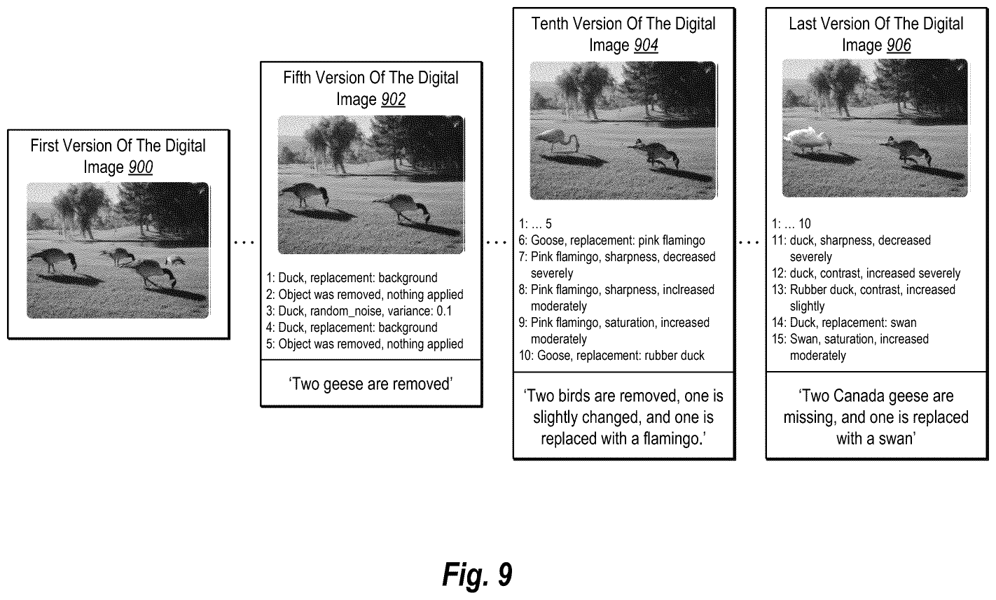

FIG. 9 illustrates an example diagram of providing a series of machine annotations and human annotations for training a model architecture for generating an image difference caption in accordance with one or more embodiments. For example, as part of training, the image difference captioning system 102 provides a series of versions of a digital image with machine annotations and human annotations. In one or more embodiments, an annotation refers to a description of edits (e.g., manipulations) applied to a digital image. Specifically, annotations include machine or human annotations. For instance, machine annotations include an edit description of a change/manipulation to a digital image generated by a large language model. Further, a human annotation refers to a human description of a change/manipulation to a digital image.

As shown in FIG. 9, for training the model architecture, the image difference captioning system 102 provides as input a series of versions of a digital image. As shown, the image difference captioning system 102 provides a whole series of versions of a digital image. Specifically, FIG. 9 shows a first version 900, a fifth version 902, a tenth version 904, and a last version of the digital image. In some embodiments, the image difference captioning system 102 only provides the human annotations at the fifth version 902, the tenth version 904 and the last version 906 (e.g., a fifteenth version). By providing the human annotations along with the machine annotations, the image difference captioning system 102 learns parameters for how to generate caption predictions that conform with human annotation conventions.

To illustrate, the first version 900 shows multiple geese and the fifth version 902 shows two geese replaced with the background (e.g., an inpainting manipulation). Specifically, the machine annotations associated with the fifth version 902 read “1: duck, replacement: background 2: object was removed, nothing applied, 3: duck, random_noise, variance: 0.1, 4: duck, replacement: background, 5: object was removed, nothing applied.” In contrast, the human annotation for the fifth version 902 reads “two geese are removed.” Accordingly, during the training process, the human annotation helps hedge against machine annotation errors.

Moreover, FIG. 9 shows the tenth version 904 of the digital image with a goose replaced with a flamingo. Specifically, the machine annotations read “6: goose, replacement: pink flamingo, 7: pink flamingo, sharpness, decreased severely, 8: pink flamingo, sharpness, increased moderately, 9: pink flamingo, saturation, increased moderately, 10: goose, replacement: rubber duck.” Further the human annotation corresponding to the tenth version 904 reads “two birds are removed, one is slightly changed, and one is replaced with a flamingo.” As shown, the human annotation captures the holistic context of the manipulations applied from a sixth version to the tenth version 904 but only reflects the changes visible between the tenth version 904 and the first version 900.

Furthermore, FIG. 9 shows the last version 906 of the digital image with the flamingo replaced with a swan. Specifically, FIG. 9 shows machine annotations that read “11: duck, sharpness, decreased severely, 12: duck, contrast, increased severely, 13: rubber duck, contrast increased slightly, 14: duck, replacement: swan, 15: swan, saturation, increased moderately.” Additionally, the human annotation corresponding to the last version 906 reads “two Canada geese are missing, and one is replaced with a swan.”

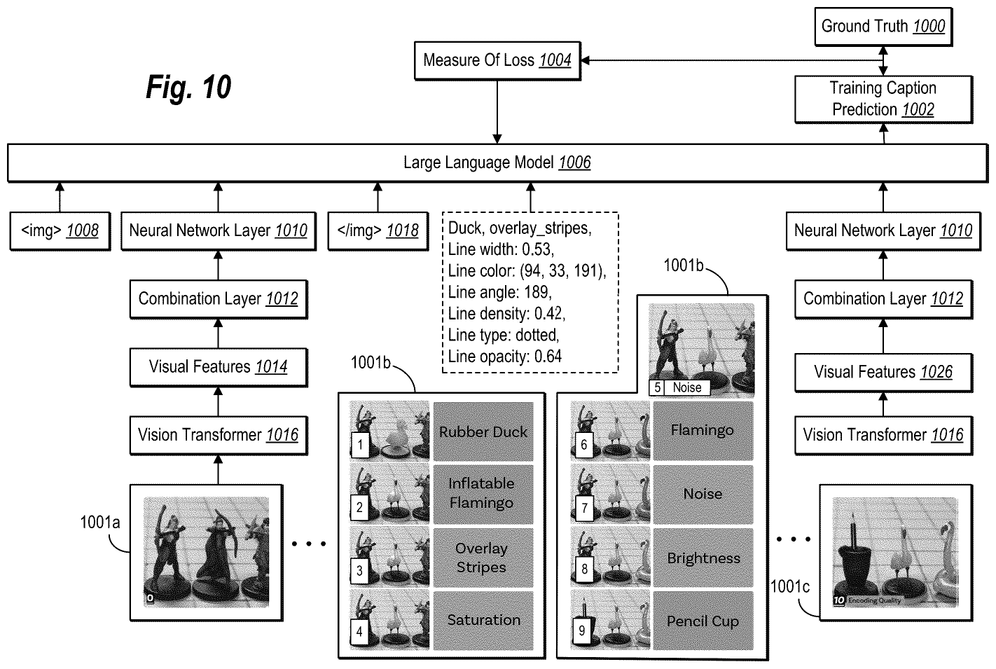

FIG. 10 illustrates an example diagram of training a large language model based on a series of versions of a digital image in accordance with one or more embodiments. Specifically, FIG. 10 shows from a series of versions of a digital image, the image difference captioning system 102 utilizes a vision transformer to generate visual features. For instance, the image difference captioning system 102 processes a first version 1001a of the digital image, intermediate versions 1001b, and a last version 1001c of the digital image utilizing a vision transformer 1016.

Similar to the description in FIG. 4, the image difference captioning system 102 generates visual features 1014 for the first version 1001a, visual features for the intermediate versions 1001b, and visual features 1026 for the last version 1001c. Moreover, the image difference captioning system 102 utilizes a combination layer 1012 to combine the visual features (e.g., into groups of four visual tokens) and further utilizes a neural network layer 1010 (e.g., linear projection layer or a MLP) to transform the visual features into text inputs.

As shown, in some embodiments, the image difference captioning system 102 also provides one or more edit descriptions corresponding with one or more versions of the series of versions to the large language model 1006 (e.g., during training). Specifically, the image difference captioning system 102 feed as input the edit descriptions interleaved with the image features to guide the attention of the large language model 1006 to relevant parts of the series of versions of the digital image. For instance, the image difference captioning system 102 feeds the edit description corresponding to a version of the digital image first to the large language model 1006, and then feeds the version of the digital image to the large language model 1006.

Moreover, in some embodiments, the image difference captioning system 102 also provides image feature tags to the large language model 1006. Specifically, the image feature tags look as follows: “[INST] <Img><ImageFeature></Img> T . . . <Img><ImageFeature><Img>T [idc] ins [/INST]. In the example image feature tags just given, the image feature tags are repeated for each input image in the sequence, T is the optional auxiliary textual information (e.g., the edit descriptions), and [idc] (e.g., image difference caption) is the instruction that is chosen at random from a set of predefined instructions. For instance, [idc] indicates to the large language model 1006 to describe the differences between the series of versions of the digital image. To illustrate, FIG. 10 shows an opening image tag 1008 (e.g., <img>) and a closing image tag 1018 (e.g., </img>) to indicate to the large language model 1006 a version of the digital image.

As shown in FIG. 10, from processing the edit description and the text inputs from the visual features, the image difference captioning system 102 utilizes the large language model 1006 to generate a training caption prediction 1002. For instance, the training caption prediction 1002 indicates an image difference between the first version 1001a and the last version 1001c of a series of versions of the training digital image.

Moreover, as shown, the image difference captioning system 102 compares the training caption prediction 1002 with a ground truth 1000 (e.g., a ground truth prediction caption). In some embodiments, the image editing sequence dataset contains ground truth annotations or a ground truth prediction caption for a series of versions of a training digital image. Specifically, the image difference captioning system 102 generates the training prediction caption and compares the training prediction caption to the ground truth prediction caption to determine a measure of loss. In particular, a measure of loss includes mean squared error loss, cross-entropy loss, Kullback-Leibler divergence loss, or hinge loss. As shown, based on the measure of loss 1004, the image difference captioning system 102 modifies parameters of the large language model 1006.

To illustrate, the image difference captioning system 102 trains the large language model 1006 to minimize a captioning loss defined as:

$$L = - {\sum }_{i = 1}^{m} l ( {s}^{v} , {s}_{1}^{t} , … , {s}_{i}^{t} )$$

In the above notation, m is a variable token length, and/is next-token log-probability defined as:

$$l ( {s}^{v} , {s}_{1}^{t} , … , {s}_{i}^{t} ) = log p ( {t}_{i} \vert x , {t}_{1} , … , {t}_{i - 1} )$$

The above notation shows that the next-token is conditioned on the previous sequence of elements.

In one or more embodiments, the image difference captioning system 102 determines the measure of loss 1004 and modifies parameters of the large language model 1006, the neural network layer 1010 (e.g., the linear projection layer or the MLP). In some embodiments, the image difference captioning system 102 freezes the vision transformer 1016. In other words, the image difference captioning system 102 does not modify parameters of the vision transformer 1016 in response to determine the measure of loss 1004.

In one or more embodiments, experimenters test the image difference captioning system 102 trained on the image editing sequence dataset (e.g., discussed above in FIG. 5) compared against training on additional datasets. For example, the experimenters utilize a first dataset that contains a large volume of training, validation, and test image pairs, where edits in the first dataset include changes in shape, color, material, size, and position of the objects. Due to the first dataset having a large volume and precise annotations, experimenters utilize it as a benchmark dataset. However, the first dataset further includes synthetic images which results in a domain gap and training on the first dataset results in difficulty in generalizing to real-world images.

Further, the experimenters utilize a second dataset with well-aligned image pairs captured from surveillance cameras (CCTV). Specifically, the images of the second dataset contain no viewpoint changes and the edits are limited to object addition, deletion, or movement. Moreover, the experimenters utilize a third dataset with real-world image pairs collected from various internet image forums. In some embodiments, the experimenters utilize the third dataset for the evaluation of generalization capacity to real-world images. Moreover, the experimenters utilize a fourth dataset containing around a million image pairs generated from a prompt-to-prompt approach where there are corresponding difference captions generated using a language model. For instance, the experimenters utilize the fourth dataset to assess the benefits of fine-tuning the image difference captioning system 102 on the image editing sequence dataset (e.g., discussed above in FIG. 5). Additionally, experimenters utilize a fifth dataset that contains sequences of images limited to three steps.

In one or more embodiments, the experimenters evaluate the image difference captioning system 102 in two different settings (1) standard image difference captioning with two images as input and (2) image difference captioning with multiple inputs. Specifically, the experimenters evaluate the performance of the image difference captioning system 102 for (1) on the first dataset, the third dataset, and the fourth dataset. Moreover, the experimenters evaluate the performance of the image difference captioning system 102 for (2) on the fifth dataset and the image editing sequence dataset (e.g., discussed above in FIG. 5).

For both (1) and (2), the experimenters use standard n-gram based metrics such as BLEU-4 (hereinafter referred to as B4, which stands for bilingual evaluation understudy and refers to a similarity between the generated text and one or more reference texts based on n-gram precision, 4 n-grams), CIDEr (hereinafter referred to as c, which stands for consensus-based image description evaluation and refers to the quality of image captions compared to human-generated captions by using weighted cosine similarity), METEOR (hereinafter referred to as M, which stands for metric for evaluation of translation with explicit ordering and refers to a harmonic mean of precision and recall of matched n-grams between generated text and reference text), ROUGE-L (hereinafter referred to as R, which stands for recall-oriented understudy for gisting evaluation and refers to measuring the overlap of n-grams between the generated text and reference texts), and SPICE (hereinafter referred to as S, which stands for semantic propositional image caption evaluation and refers to evaluating the semantic content of image captions by analyzing the presence of semantic triples, such as subject-relationship-object, and their accuracy) to evaluate the performance of the image difference captioning system 102.

Moreover, for (2), the experimenters evaluate the performance of the image difference captioning system 102 while varying the number of input images and the presence of auxiliary textual information (e.g., machine annotations). Specifically, the experimenters compare the image difference captioning system 102 performance with a multi-modal model and a text model (e.g., to only take as input the auxiliary text).

To illustrate, compared to the base case of just a two-image input, the addition of the auxiliary textual information (e.g., the edit descriptions) to the image difference captioning system 102 improves the performance by an average of 18.9% across all metrics. Moreover, the presence of intermediate versions of a series of versions of a digital image also improves the performance by an average of 10.1% across all metrics. Furthermore, the combination of both intermediate versions and textual information shows an average improvement of 22.4% across all metrics. In contrast, the performance of a multi-modal model suffers from the addition of intermediate versions of a digital image, resulting in a decrease in performance with the addition of both extra versions of the digital image and text.

Turning to FIG. 11, additional detail will now be provided regarding various components and capabilities of the image difference captioning system 102. In particular, FIG. 11 illustrates an example schematic diagram of a computing device 1100 (e.g., the server(s) 104 and/or the client device 116) implementing the image difference captioning system 102 in accordance with one or more embodiments of the present disclosure for components 1100-1112. As illustrated in FIG. 11, the image difference captioning system 102 includes an image difference captioning request manager 1102, an edit description manager 1104, a text input generator 1106, a vision transformer 1108, a caption prediction manager 1110, a large language model 1112, and a storage manager 1114.

The image difference captioning request manager 1102 receives requests from client devices. For example, the image difference captioning request manager 1102 provides to a client device an option to submit an image difference captioning request. Furthermore, the image difference captioning request manager 1102 also provides as part of submitting the request, an option to submit a digital image. For instance, the image difference captioning request manager 1102 detects when a received request and digital image contains a series of versions and a series of manipulations applied to the series of versions.

The edit description manager 1104 accesses edit descriptions corresponding to an image difference captioning request. For example, the edit description manager 1104 accesses the digital image (e.g., the series of versions of the digital image) and further accesses edit descriptions that are related to the manipulations applied to the digital image. Further, in some embodiments, the edit description manager 1104 obtains metadata tags from the digital image that textually indicate various manipulations applied to the digital image. Moreover, in some embodiments, the edit description manager 1104 accesses the edit descriptions that include edit parameters and various types of edits applied to the digital image.

In addition, the text input generator 1106 generates text inputs. For example, the text input generator 1106 receives an indication from the image difference captioning request manager 1102 of the received image difference captioning request and generates text inputs. Further, the text input generator 1106 generates the text inputs from the series of versions of the digital image. Moreover, in some embodiments, the text input generator 1106 generates the text inputs from both the series of versions of the digital image and one or more edit descriptions received from the edit description manager 1104.

The vision transformer 1108 works in tandem with the text input generator 1106. For example, the vision transformer 1108 receives the series of versions of the digital image and breaks down the series of versions of the digital image into multiple image patches. Furthermore, the vision transformer 1108 generates embeddings or visual features from the multiple image patches based on the identified visual features (e.g., both global and local features of the image patches). Thus, the vision transformer 1108 generates visual features of the series of versions of the digital image and works with the text input generator 1106 to generate the text inputs from the visual features.

The caption prediction manager 1110 generates a caption prediction. For example, the caption prediction manager 1110 generates a caption prediction that indicates a difference between a first version of the digital image and a last version of the digital image. For instance, the caption prediction manager 1110 processes text inputs from the visual features and text inputs from one or more edit descriptions to generate the caption prediction.

The large language model 1112 generates the caption prediction from various text inputs. For example, the large language model 1112 works in tandem with the caption prediction manager 1110. For instance, the large language model 1112 processes the text inputs compatible with the embedding space of the large language model 1112 and generates the caption prediction.

The storage manager 1114 stores one or more items generated by the image difference captioning system 102. For example, the storage manager 1114 stores image difference captioning requests, digital images, and edit descriptions. For instance, the storage manager 1114 stores multiple series of versions of digital images and the corresponding edit descriptions that are available. Furthermore, in some embodiments, the storage manager 1114 stores visual features, text inputs, and caption predictions generated by the large language model.

Each of the components 1102-1114 of the image difference captioning system 102 can include software, hardware, or both. For example, the components 1102-1114 can include one or more instructions stored on a computer-readable storage medium and executable by processors of one or more computing devices, such as a client device or server device. When executed by the one or more processors, the computer-executable instructions of the image difference captioning system 102 can cause the computing device(s) to perform the methods described herein. Alternatively, the components 1102-1114 can include hardware, such as a special-purpose processing device to perform a certain function or group of functions. Alternatively, the components 1102-1114 of the image difference captioning system 102 can include a combination of computer-executable instructions and hardware.

Furthermore, the components 1102-1114 of the image difference captioning system 102 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 1102-1114 of the image difference captioning system 102 may be implemented as a stand-alone application, such as a desktop or mobile application. Furthermore, the components 1102-1114 of the image difference captioning system 102 may be implemented as one or more web-based applications hosted on a remote server. Alternatively, or additionally, the components 1102-1114 of the image difference captioning system 102 may be implemented in a suite of mobile device applications or “apps.” For example, in one or more embodiments, the image difference captioning system 102 can comprise or operate in connection with digital software applications such as ADOBE® FIREFLY®, ADOBE® PHOTOSHOP®, ADOBE® ILLUSTRATOR®, and/or ADOBE® INDESIGN®.

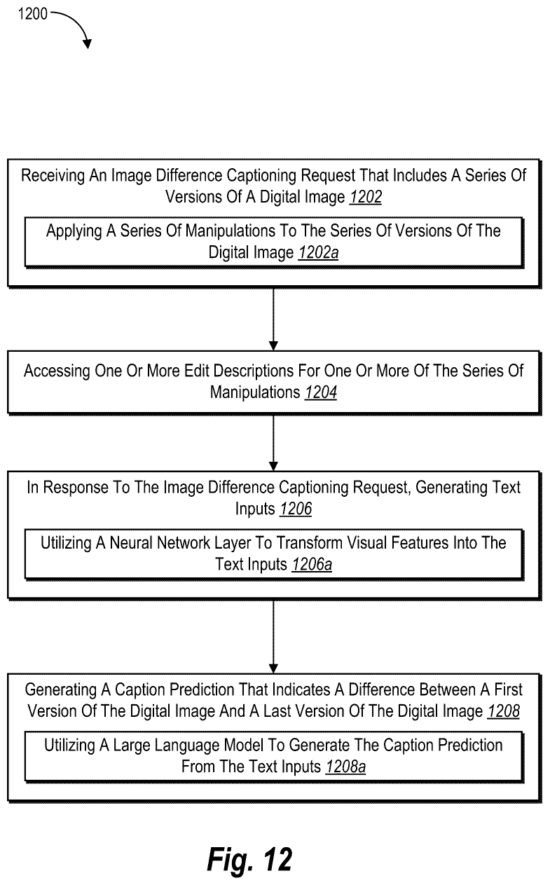

FIGS. 1-11, the corresponding text, and the examples provide a number of different methods, systems, devices, and non-transitory computer-readable media of the 1102-1114. In addition to the foregoing, one or more embodiments can also be described in terms of flowcharts comprising acts for accomplishing the particular result, as shown in FIG. 12. FIG. 12 may be performed with more or fewer acts. Further, the acts may be performed in different orders. Additionally, the acts described herein may be repeated or performed in parallel with one another or in parallel with different instances of the same or similar acts.

FIG. 12 illustrates a flowchart of a series of acts 1200 for modifying parameters in accordance with one or more embodiments. FIG. 12 illustrates acts according to one embodiment, alternative embodiments may omit, add to, reorder, and/or modify any of the acts shown in FIG. 12. In some implementations, the acts of FIG. 12 are performed as part of a method. For example, in some embodiments, the acts of FIG. 12 are performed as part of a computer-implemented method. Alternatively, a non-transitory computer-readable medium can store instructions thereon that, when executed by at least one processor, cause a computing device to perform the acts of FIG. 12 In some embodiments, a system performs the acts of FIG. 12. For example, in one or more embodiments, a system includes at least one memory device. The system further includes at least one server device configured to cause the system to perform the acts of FIG. 12.

The series of acts 1200 includes an act 1202 of generating receiving an image difference captioning request that includes a series of versions of a digital image. Further, the act 1202 includes a sub-act 1202a of applying a series of manipulations to the series of versions of the digital image. Moreover, series of acts 1200 includes an act 1204 of accessing one or more edit descriptions for one or more of the series of manipulations. Moreover, the series of acts 1200 includes an act 1206 of in response to the image difference captioning request, generating text inputs. Further the act 1208 includes a sub-act 1206a of utilizing a neural network layer to transform visual features into the text inputs. Moreover, the series of acts 1200 includes an act 1208 of generating a caption prediction that indicates a difference between a first version of the digital image and a last version of the digital image. Further, the act 1208 includes a sub-act 1208a of utilizing a large language model to generate the caption prediction from the text inputs.

In particular, the act 1202 includes receiving, from a client device, an image difference captioning request comprising a series of versions of a digital image with a series of manipulations applied to the series of versions of the digital image. Moreover, the act 1204 includes accessing one or more edit descriptions for one or more of the series of manipulations. Further, the act 1206 includes in response to the image difference captioning request, generating text inputs from the series of versions of the digital image and the one or more edit descriptions. Moreover, the act 1208 includes generating, from the text inputs utilizing a large language model, a caption prediction that indicates a difference between a first version of the digital image of the series of versions of the digital image and a last version of the digital image of the series of versions of the digital image.

For example, in one or more embodiments, the series of acts 1200 includes determining a type of manipulation and parameters of one or more of the series of manipulations. In addition, in one or more embodiments, the series of acts 1200 includes identifying a binary mask for applying one or more of the series of manipulations. Further, in one or more embodiments, the series of acts 1200 includes generating, utilizing a vision transformer, visual features of the series of versions of the digital image. Further, in some embodiments, the series of acts 1200 includes transforming, utilizing a neural network layer, the visual features into the text inputs for compatibility in an embedding space of the large language model.

Moreover, in one or more embodiments, the series of acts 1200 includes extracting, utilizing the vision transformer, a plurality of image patches from the first version of the digital image of the series of versions of the digital image. Further, in one or more embodiments, the series of acts 1200 includes generating, utilizing a combination neural network layer, the visual features by combining visual tokens corresponding to the plurality of image patches. Moreover, in one or more embodiments, the series of acts 1200 includes receiving the series of versions of the digital image comprises receiving the first version of the digital image, the last version of the digital image, and a plurality of intermediate versions of the digital image. Further, in one or more embodiments, the series of acts 1200 includes generating the caption prediction comprises utilizing context of the plurality of intermediate versions of the digital image to generate the caption prediction that indicates the difference between the first version of the digital image and the last version of the digital image.

Moreover, in one or more embodiments, the series of acts 1200 includes generating, utilizing a vision transformer, a first group of visual features from the first version of the digital image. Additionally, in one or more embodiments, the series of acts 1200 includes generating, utilizing the vision transformer, a second group of visual features from an intermediate version of the digital image of the series of versions of the digital image. Moreover, in one or more embodiments, series of acts 1200 includes transforming, utilizing a neural network layer, the first group of visual features and the second group of visual features into the text inputs for the large language model. Further, in one or more embodiments, the series of acts 1200 includes generating, utilizing the large language model, the caption prediction from the text inputs of the first group of visual features and the second group of visual features.

Furthermore, in one or more embodiments, the series of acts 1200 includes accessing a training digital image comprising a plurality of non-overlapping binary masks. Moreover, in one or more embodiments, the series of acts 1200 includes applying a first manipulation to the training digital image, the first manipulation determined utilizing a manipulation model. In one or more embodiments, the series of acts 1200 includes applying a second manipulation to the training digital image, the second manipulation determined based on the first manipulation and utilizing the manipulation model.

Moreover, in one or more embodiments, the series of acts 1200 includes generating an image editing sequence dataset comprising versions of the training digital image, the plurality of non-overlapping binary masks, and annotations for the first manipulation and the second manipulation. Further, in one or more embodiments, the series of acts 1200 includes generating a training prediction caption from the versions of the training digital image. Moreover, in one or more embodiments, the series of acts 1200 includes comparing the training prediction caption with a ground truth prediction caption to determine a measure of loss. Further, in one or more embodiments, the series of acts 1200 includes modifying parameters of the large language model based on the measure of loss.

In one or more embodiments, the series of acts 1200 includes receiving, from a client device, a series of versions of a digital image with a series of manipulations applied to the series of versions of the digital image and one or more edit descriptions for one or more of the series of manipulations. Further, in one or more embodiments, the series of acts 1200 includes generating, utilizing a vision transformer, a first group of visual features for a first version of the digital image of the series of versions of the digital image. Moreover, in one or more embodiments, the series of acts 1200 includes transform, utilizing a neural network layer, the first group of visual features to a first group of text inputs for compatibility in an embedding space of a large language model. Further, in one or more embodiments, the series of acts 1200 includes generating additional text inputs from the one or more edit descriptions for one or more of the series of manipulations. Moreover, in one or more embodiments, the series of acts 1200 includes generating, from the first group of text inputs and the additional text inputs utilizing the large language model, a caption prediction that indicates a difference between the first version of the digital image of the series of versions of the digital image and a last version of the digital image of the series of versions of the digital image.

Further, in one or more embodiments, the series of acts 1200 includes generating, for the first version of the digital image of the series of versions of the digital image, a plurality of image patches. Moreover, in one or more embodiments, the series of acts 1200 includes generating, utilizing the vision transformer, visual tokens corresponding to the plurality of image patches. Additionally, in one or more embodiments, the series of acts 1200 includes generating, utilizing a concatenation layer, the first group of visual features by combining the visual tokens.

Moreover, in one or more embodiments, the series of acts 1200 includes transforming the first group of visual features to the first group of text inputs in the embedding space of the large language model by utilizing a linear projection layer or a multi-layer perceptron. Further, in one or more embodiments, the series of acts 1200 includes generating the additional text inputs from the one or more edit descriptions based on a type of manipulation and parameters of one or more of the series of manipulations. Moreover, in one or more embodiments, the series of acts 1200 includes generating the caption prediction by utilizing context from a plurality of intermediate versions of the series of versions of the digital image.

Further, in one or more embodiments, the series of acts 1200 includes generating an image editing sequence dataset comprising a training digital image and a plurality of non-overlapping binary masks. In one or more embodiments, the series of acts 1200 includes generating a training prediction caption from a series of versions of the training digital image. Further, in one or more embodiments, the series of acts 1200 includes comparing the training prediction caption with a ground truth prediction caption to determine a measure of loss. Moreover, in one or more embodiments, the series of acts 1200 includes modifying parameters of the large language model based on the measure of loss.

In one or more embodiments, the series of acts 1200 includes generating, utilizing a vision transformer, a first group of visual features corresponding to a first version of a digital image of a series of versions of the digital image. Further, in one or more embodiments, the series of acts 1200 includes generating, utilizing the vision transformer, a second group of visual features corresponding to a second versions of the digital image of the series of versions of the digital image. Moreover, in one or more embodiments, the series of acts 1200 includes receiving an image difference caption request from a client device. Further, in one or more embodiments, the series of acts 1200 includes generating, utilizing a large language model, a caption prediction that indicates a difference between the first version of the digital image and a last version of the digital image of the series of versions of the digital image based on the first group of visual features and the second group of visual features. Moreover, in one or more embodiments, the series of acts 1200 includes providing the caption prediction that indicates the difference between the first version of the digital image and the last version of the digital image of the series of versions of the digital image to the client device.

Further, in one or more embodiments, the series of acts 1200 includes accessing one or more edit descriptions for one or more of a series of manipulations applied to the series of versions of the digital image. In one or more embodiments, the series of acts 1200 includes generating, utilizing a neural network layer, text inputs from the first group of visual features and the second group of visual features. Further, in one or more embodiments, the series of acts 1200 includes generating additional text inputs from the one or more edit descriptions. Moreover, in one or more embodiments, the series of acts 1200 includes generating, utilizing the large language model to process the text inputs and the additional text inputs, the caption prediction.

Further, in one or more embodiments, the series of acts 1200 includes generating an image editing sequence dataset comprising a training digital image, a plurality of non-overlapping binary masks, and annotations for a first manipulation and a second manipulation applied to the training digital image. In one or more embodiments, the series of acts 1200 includes generating, utilizing the large language model, a training prediction caption from a series of versions of the training digital image. Further, in one or more embodiments, the series of acts 1200 includes comparing the training prediction caption with a ground truth prediction caption to determine a measure of loss. Moreover, in one or more embodiments, the series of acts 1200 includes modifying parameters of the large language model based on the measure of loss.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 13 illustrates a block diagram of an example computing device 1300 that may be configured to perform one or more of the processes described above. One will appreciate that one or more computing devices, such as the computing device 1300 may represent the computing devices described above (e.g., the server(s) 104 and/or the client device 116). In one or more embodiments, the computing device 1300 may be a mobile device (e.g., a mobile telephone, a smartphone, a PDA, a tablet, a laptop, a camera, a tracker, a watch, a wearable device). In some embodiments, the computing device 1300 may be a non-mobile device (e.g., a desktop computer or another type of client device). Further, the computing device 1300 may be a server device that includes cloud-based processing and storage capabilities.

As shown in FIG. 13, the computing device 1300 can include one or more processor(s) 1302, memory 1304, a storage device 1306, input/output interfaces 1308 (or “I/O interfaces 1308”), and a communication interface 1310, which may be communicatively coupled by way of a communication infrastructure (e.g., bus 1312). While the computing device 1300 is shown in FIG. 13, the components illustrated in FIG. 13 are not intended to be limiting. Additional or alternative components may be used in other embodiments. Furthermore, in certain embodiments, the computing device 1300 includes fewer components than those shown in FIG. 13. Components of the computing device 1300 shown in FIG. 13 will now be described in additional detail.

In particular embodiments, the processor(s) 1302 include hardware for executing instructions, such as those making up a computer program. As an example, and not by way of limitation, to execute instructions, the processor(s) 1302 may retrieve (or fetch) the instructions from an internal register, an internal cache, memory 1304, or a storage device 1306 and decode and execute them.

The computing device 1300 includes memory 1304, which is coupled to the processor(s) 1302. The memory 1304 may be used for storing data, metadata, and programs for execution by the processor(s). The memory 1304 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 1304 may be internal or distributed memory.

The computing device 1300 includes a storage device 1306 including storage for storing data or instructions. As an example, and not by way of limitation, the storage device 1306 can include a non-transitory storage medium described above. The storage device 1306 may include a hard disk drive (HDD), flash memory, a Universal Serial Bus (USB) drive or a combination these or other storage devices.

As shown, the computing device 1300 includes one or more I/O interfaces 1308, which are provided to allow a user to provide input to (such as user strokes), receive output from, and otherwise transfer data to and from the computing device 1300. These I/O interfaces 1308 may include a mouse, keypad or a keyboard, a touch screen, camera, optical scanner, network interface, modem, other known I/O devices or a combination of such I/O interfaces 1308. The touch screen may be activated with a stylus or a finger.

The I/O interfaces 1308 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 1308 are configured to provide graphical data to a display for presentation to a user. The graphical data may be representative of one or more graphical user interfaces and/or any other graphical content as may serve a particular implementation.

The computing device 1300 can further include a communication interface 1310. The communication interface 1310 can include hardware, software, or both. The communication interface 1310 provides one or more interfaces for communication (such as, for example, packet-based communication) between the computing device and one or more other computing devices or one or more networks. As an example, and not by way of limitation, communication interface 1310 may include a network interface controller (NIC) or network adapter for communicating with an Ethernet or other wire-based network or a wireless NIC (WNIC) or wireless adapter for communicating with a wireless network, such as a WI-FI. The computing device 1300 can further include a bus 1312. The bus 1312 can include hardware, software, or both that connects components of computing device 1300 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed:

1. A computer-implemented method comprising:
receiving, from a client device, an image difference captioning request comprising a series of versions of a digital image with a series of manipulations applied to the series of versions of the digital image;
accessing one or more edit descriptions for one or more of the series of manipulations;
in response to the image difference captioning request, generating text inputs from the series of versions of the digital image and the one or more edit descriptions; and
generating, from the text inputs utilizing a large language model, a caption prediction that indicates a difference between a first version of the digital image of the series of versions of the digital image and a last version of the digital image of the series of versions of the digital image.

2. The computer-implemented method of claim 1, wherein accessing the one or more edit descriptions comprises:
determining a type of manipulation and parameters of one or more of the series of manipulations; and
identifying a binary mask for applying one or more of the series of manipulations.

3. The computer-implemented method of claim 1, further comprising:
generating, utilizing a vision transformer, visual features of the series of versions of the digital image; and
transforming, utilizing a neural network layer, the visual features into the text inputs for compatibility in an embedding space of the large language model.

4. The computer-implemented method of claim 3, further comprising:
extracting, utilizing the vision transformer, a plurality of image patches from the first version of the digital image of the series of versions of the digital image; and
generating, utilizing a combination neural network layer, the visual features by combining visual tokens corresponding to the plurality of image patches.

5. The computer-implemented method of claim 1, wherein:
receiving the series of versions of the digital image comprises receiving the first version of the digital image, the last version of the digital image, and a plurality of intermediate versions of the digital image; and
generating the caption prediction comprises utilizing context of the plurality of intermediate versions of the digital image to generate the caption prediction that indicates the difference between the first version of the digital image and the last version of the digital image.

6. The computer-implemented method of claim 1, further comprising:
generating, utilizing a vision transformer, a first group of visual features from the first version of the digital image; and
generating, utilizing the vision transformer, a second group of visual features from an intermediate version of the digital image of the series of versions of the digital image.

7. The computer-implemented method of claim 6, further comprising:
transforming, utilizing a neural network layer, the first group of visual features and the second group of visual features into the text inputs for the large language model; and
generating, utilizing the large language model, the caption prediction from the text inputs of the first group of visual features and the second group of visual features.

8. The computer-implemented method of claim 1, further comprising training the large language model by:
accessing a training digital image comprising a plurality of non-overlapping binary masks;
applying a first manipulation to the training digital image, the first manipulation determined utilizing a manipulation model; and
applying a second manipulation to the training digital image, the second manipulation determined based on the first manipulation and utilizing the manipulation model.

9. The computer-implemented method of claim 8, further comprises:
generating an image editing sequence dataset comprising versions of the training digital image, the plurality of non-overlapping binary masks, and annotations for the first manipulation and the second manipulation;
generating a training prediction caption from the versions of the training digital image;
comparing the training prediction caption with a ground truth prediction caption to determine a measure of loss; and
modifying parameters of the large language model based on the measure of loss.

10. A system comprising:
one or more memory devices; and
one or more processors configured to cause the system to:
receive, from a client device, a series of versions of a digital image with a series of manipulations applied to the series of versions of the digital image and one or more edit descriptions for one or more of the series of manipulations;
generate, utilizing a vision transformer, a first group of visual features for a first version of the digital image of the series of versions of the digital image;
transform, utilizing a neural network layer, the first group of visual features to a first group of text inputs for compatibility in an embedding space of a large language model;
generate additional text inputs from the one or more edit descriptions for one or more of the series of manipulations; and
generate, from the first group of text inputs and the additional text inputs utilizing the large language model, a caption prediction that indicates a difference between the first version of the digital image of the series of versions of the digital image and a last version of the digital image of the series of versions of the digital image.

11. The system of claim 10, wherein the one or more processors are configured to cause the system to:
generate, for the first version of the digital image of the series of versions of the digital image, a plurality of image patches;
generate, utilizing the vision transformer, visual tokens corresponding to the plurality of image patches; and
generate, utilizing a concatenation layer, the first group of visual features by combining the visual tokens.

12. The system of claim 10, wherein the one or more processors are configured to cause the system to transform the first group of visual features to the first group of text inputs in the embedding space of the large language model by utilizing a linear projection layer or a multi-layer perceptron.

13. The system of claim 10, wherein the one or more processors are configured to cause the system to generate the additional text inputs from the one or more edit descriptions based on a type of manipulation and parameters of one or more of the series of manipulations.

14. The system of claim 10, wherein the one or more processors are configured to cause the system to generate the caption prediction by utilizing context from a plurality of intermediate versions of the series of versions of the digital image.

15. The system of claim 10, wherein the one or more processors are configured to cause the system to train the large language model by:
generating an image editing sequence dataset comprising a training digital image and a plurality of non-overlapping binary masks;
generating a training prediction caption from a series of versions of the training digital image;
comparing the training prediction caption with a ground truth prediction caption to determine a measure of loss; and
modifying parameters of the large language model based on the measure of loss.

16. A non-transitory computer-readable medium storing executable instructions which, when executed by at least one processing device, cause the at least one processing device to perform operations comprising:
generating, utilizing a vision transformer, a first group of visual features corresponding to a first version of a digital image of a series of versions of the digital image;
generating, utilizing the vision transformer, a second group of visual features corresponding to a second versions of the digital image of the series of versions of the digital image;
receiving an image difference caption request from a client device;
generating, utilizing a large language model, a caption prediction that indicates a difference between the first version of the digital image and a last version of the digital image of the series of versions of the digital image based on the first group of visual features and the second group of visual features; and
providing the caption prediction that indicates the difference between the first version of the digital image and the last version of the digital image of the series of versions of the digital image to the client device.

17. The non-transitory computer-readable medium of claim 16, wherein the operations further comprise accessing one or more edit descriptions for one or more of a series of manipulations applied to the series of versions of the digital image.

18. The non-transitory computer-readable medium of claim 17, wherein the operations further comprise:
generating, utilizing a neural network layer, text inputs from the first group of visual features and the second group of visual features;
generating additional text inputs from the one or more edit descriptions; and
generating, utilizing the large language model to process the text inputs and the additional text inputs, the caption prediction.

19. The non-transitory computer-readable medium of claim 16, wherein the operations further comprise training the large language model by:
generating an image editing sequence dataset comprising a training digital image, a plurality of non-overlapping binary masks, and annotations for a first manipulation and a second manipulation applied to the training digital image; and
generating, utilizing the large language model, a training prediction caption from a series of versions of the training digital image.

20. The non-transitory computer-readable medium of claim 19, wherein the operations further comprise:
comparing the training prediction caption with a ground truth prediction caption to determine a measure of loss; and
modifying parameters of the large language model based on the measure of loss.
